(19) United States
(12) Patent Application Publication
(10) Pub. No.: US 2026/0298020 A1
(43) Pub. Date: Oct. 1, 2026

(54) IMPACT RESISTANT LOUVER

(71) Applicant: Greenheck Fan Corporation, Schofield, WI (US)

(72) Inventors: Ryan N. Trzebiatowski, Amherst, WI (US); Morgan E. Wirkes, Schofield, WI (US); Brandon C. Black, Wausau, WI (US); Michael E. Steele, Schofield, WI (US); Keith A. Krake, Weston, WI (US); Kayleigh M. Frieders, Stettin, WI (US); Jon A. Jackson, Wausau, WI (US)

(21) Appl. No.: 19/094,277

(22) Filed: Mar. 28, 2025

Related U.S. Application Data
(60) Provisional application No. 63/572,069, filed on Mar. 29, 2024.

(51) Int. Cl. E06B 7/082

(52) U.S. Cl. CPC E06B 7/082

(57) ABSTRACT

A louver assembly for enhanced performance against wind-driven rain and compliance with impact resistance standards for louver assemblies including an exterior frame including an exterior sill, exterior jambs, and an exterior head, wherein each of the exterior sill, the exterior jambs, and the exterior head are formed of an extruded metal, a plurality of exterior blades arranged in parallel and coupled to the exterior frame in a first orientation, an interior frame including an interior sill, interior jambs and an interior head configured to be received within the exterior frame, and a plurality of interior blades arranged in parallel, and coupled to the interior frame in a second orientation, wherein the second orientation is substantially orthogonal to the first orientation.

### CROSS-REFERENCE TO RELATED APPLICATION

This application claims the benefit of U.S. Provisional Application No. 63/572,069, filed Mar. 29, 2024, the disclosure of which is hereby incorporated by reference in its entirety.

### TECHNICAL FIELD

The present disclosure relates generally to heating, ventilation and air conditioning (HVAC) equipment, and more particularly to a wind driven rain performance, impact-rated ventilation louver.

### BACKGROUND

Ventilation louvers, classified as “impact-resistant” and/or “hurricane-rated,” are engineered to endure the forces of high winds and resist penetration by airborne debris, a necessity for architectural components in locales susceptible to extreme weather events such as hurricanes and tornadoes. Their usage is advised, if not mandated, within coastal areas and regions vulnerable to such natural disasters, aiming to fortify the structural integrity of buildings and safeguard the well-being of their inhabitants. These specialized louvers are incorporated into the architectural strategy of constructing disaster-resilient buildings, facilitating air exchange by covering intake or exhaust openings, while meeting the stringent construction standards which dictate comprehensive guidelines for the design and construction of safe rooms and storm shelters, ensuring a high level of protection against the destructive forces unleashed by severe weather conditions.

### SUMMARY

Embodiments described herein can provide a louver assembly configured for integration into HVAC systems designed to address the demands of environments exposed to severe weather phenomena. The assembly can include an exterior frame, constructed from extruded metal, having an exterior sill, exterior jambs, and an exterior head. Multiple exterior louver blades can be aligned in parallel and affixed to the exterior frame in a predetermined orientation to enable airflow while resisting debris impaction. An interior frame, accommodated within the exterior frame can support a set of interior louver blades, also arranged in parallel but in an orientation substantially orthogonal to that of the exterior blades, collectively serving to facilitate enhanced air exchange while improving the assembly's resilience to wind-driven rain and airborne debris impacts.

In one aspect, the present disclosure provides a louver assembly, including an exterior frame including an exterior sill, exterior jambs, and an exterior head, wherein each of the exterior sill, the exterior jambs, and the exterior head are formed of an extruded metal, a plurality of exterior louver blades arranged in parallel and coupled to the exterior frame in a first orientation, an interior frame including a top, a bottom, and a pair of side portions configured to be received within the exterior frame, and a plurality of interior louver blades arranged in parallel, and coupled to the interior frame in a second orientation, wherein the second orientation is substantially orthogonal to the first orientation.

In one aspect, each of the plurality of exterior louver blades is defined by a V-shaped form including a curved portion and an exterior louver blade portion, the curved portion extending along a radius between an apex and a second end, and the exterior louver blade portion extending at an angle from the apex.

In one aspect, each of the plurality of interior louver blades comprises a curved member extending over a distance between a first end and a second end, defining an arcuate curve with an apex positioned between the first end and the second end, and including a first hook positioned near the apex and a second hook positioned near the second end for securement to the interior frame.

In one aspect, the exterior sill, the exterior jambs, and the exterior head are formed of an extruded metal, and are joined to one another at respective corners through at least one of welding, mechanical fasteners, or combination thereof.

In one aspect, the plurality of exterior louver blades are coupled to the exterior jambs of the exterior frame with mechanical fasteners in a substantially horizontal orientation when the louver assembly is mounted to an exterior building wall.

In one aspect, each of the exterior sill, the exterior jambs, the exterior head, and each of the plurality of exterior louver blades are formed of an extruded 6005-T5 aluminum having a nominal wall thickness ranging from about 3/16 inches to about ¼ inches.

In one aspect, the exterior frame further comprises at least one of a flange mounting surface or a cantilever mounting surface extending from the exterior frame to establish either a flush or a cantilevered mounting configuration with an exterior building wall.

A louver assembly can include a frame; a first plurality of blades secured to the frame, the first plurality of blades being spaced apart and extending parallel to each other in a first direction, the first plurality of blades having a chevron-shape; and a second plurality of blades secured to the frame, the second plurality of blades being spaced apart and extending parallel to each other in a second direction orthogonal to the first direction, the first plurality of blades being provided with an arc-shape; wherein the louver assembly meets a minimum impact resistance test threshold and a minimum moisture penetration test threshold; the minimum impact resistance test threshold being defined as a louver assembly that prevents a projectile, weighing at least nine pounds and having a 2×4 inch cross-section, travelling at least at 34 miles per hour (mph), from penetrating through the louver assembly; the minimum moisture penetration test threshold being defined as a louver assembly that prevents no more than 1% of a horizontally sprayed water stream, flowing at a rate of at least 3 inches per hour, from penetrating through the louver assembly.

In some examples, the louver assembly is capable of withstanding a structural loading of greater than 300 pounds per square foot. In some examples, the louver assembly is capable of withstanding a structural loading of at least 350 pounds per square foot.

In some examples, the minimum impact resistance threshold is defined by ICC-500-2023.

In some examples, the louver assembly has a beginning point of water penetration of at least 1000 feet per minute, as defined within AMCA 511-2022.

In some examples, the minimum moisture penetration test threshold is defined by AMCA 500-L-2023, and wherein the louver assembly has a rejection rate of water greater than 99%, for both a 29 mph test and a 50 mph test, as defined within AMCA 500-L-2023.

In some examples, the minimum moisture penetration test threshold is defined by AMCA 550-2022, with less than 1% of a total sprayed water volume penetrated behind the louver assembly, as defined within AMCA 550-2022.

A louver assembly can include an exterior frame; and a plurality of chevron-shaped exterior louver blades, wherein each chevron-shaped exterior louver blade extends from a first end to a second end, with an apex located therebetween, wherein each chevron-shaped exterior louver blade defines one or more fastener receptacle located between the apex and the second end, facilitating attachment of each chevron-shaped exterior louver blade to the exterior frame, wherein each of the exterior louver blades is free from a fastener receptacle proximate a front end of the blade.

In some examples, the louver assembly is capable of withstanding a structural loading of at least 350 pounds per square foot.

In some examples, the louver assembly complies with standards equivalent to those specified for storm shelter design and construction, as verified through third-party testing and certification by recognized services, enabling its application in structures designed for severe weather protection.

In some examples, the louver assembly conforms to the Air Movement and Control Association's (AMCA) specification for static water penetration resistance, achieving a Beginning Point of Water Penetration at a wind velocity of 1250 feet per minute.

In some examples, the louver assembly meets the requirements of the dynamic water test for louver products, demonstrating a water rejection rate exceeding 99% in tests conducted at wind speeds of both 29 miles per hour and 50 miles per hour.

In some examples, the louver assembly adheres to the high-velocity wind-driven rain resistance standard, allowing no more than 1% of the total water volume sprayed during testing to penetrate beyond the louver.

In some examples, the louver assembly meets the criteria for resistance to wind-borne debris at Missile Level E, as defined in the relevant AMCA standard.

A louver assembly can include an exterior frame including an exterior sill, exterior jambs, and an exterior head; a plurality of exterior louver blades arranged in parallel and mechanically coupled to the exterior frame in a first orientation; and a plurality of interior louver blades arranged in parallel and mechanically coupled to the exterior frame in a second orientation, wherein the second orientation is substantially orthogonal to the first orientation.

In some examples, the louver assembly is capable of withstanding a structural loading of at least 350 pounds per square foot.

In some examples, the louver assembly complies with standards equivalent to those specified for storm shelter design and construction, as verified through third-party testing and certification by recognized services, enabling its application in structures designed for severe weather protection.

In some examples, the louver assembly conforms to the Air Movement and Control Association's (AMCA) specification for static water penetration resistance, achieving a Beginning Point of Water Penetration at a wind velocity of 1250 feet per minute.

In some examples, the louver assembly meets the requirements of the dynamic water test for louver products, demonstrating a water rejection rate exceeding 99% in tests conducted at wind speeds of both 29 miles per hour and 50 miles per hour.

In some examples, the louver assembly adheres to the high-velocity wind-driven rain resistance standard, allowing no more than 1% of the total water volume sprayed during testing to penetrate beyond the louver.

In some examples, the louver assembly meets the criteria for resistance to wind-borne debris at Missile Level E, as defined in the relevant AMCA standard.

A louver assembly can include an exterior frame; a plurality of chevron-shaped exterior louver blades mechanically coupled to the exterior frame; and a plurality of interior louver blades mechanically coupled to the exterior frame; wherein the louver assembly meets criteria for storm resistance designed in accordance with standards for storm shelters to resist high-velocity wind-driven rain, debris impact, and to ensure structural integrity during severe weather conditions.

In some examples, the louver assembly is capable of withstanding a structural loading of at least 350 pounds per square foot.

In some examples, the louver assembly complies with standards equivalent to those specified for storm shelter design and construction, as verified through third-party testing and certification by recognized services, enabling its application in structures designed for severe weather protection.

In some examples, the louver assembly conforms to the Air Movement and Control Association's (AMCA) specification for static water penetration resistance, achieving a Beginning Point of Water Penetration at a wind velocity of 1250 feet per minute.

In some examples, the louver assembly meets the requirements of the dynamic water test for louver products, demonstrating a water rejection rate exceeding 99% in tests conducted at wind speeds of both 29 miles per hour and 50 miles per hour.

In some examples, the louver assembly adheres to the high-velocity wind-driven rain resistance standard, allowing no more than 1% of the total water volume sprayed during testing to penetrate beyond the louver.

In some examples, the louver assembly meets the criteria for resistance to wind-borne debris at Missile Level E, as defined in the relevant AMCA standard.

A louver assembly can include an exterior frame equipped with a horizontally extending exterior sill, vertically positioned opposing exterior jambs, a horizontally positioned exterior head, and a plurality of exterior louver blades; wherein the horizontally extending exterior sill, the vertically positioned opposing exterior jambs, the horizontally positioned exterior head, and the plurality of exterior louver blades are each fabricated from an extruded material, providing structural integrity and weather resistance to the louver assembly.

In some examples, the louver assembly is capable of withstanding a structural loading of at least 350 pounds per square foot.

In some examples, the louver assembly complies with standards equivalent to those specified for storm shelter design and construction, as verified through third-party testing and certification by recognized services, enabling its application in structures designed for severe weather protection.

In some examples, the louver assembly conforms to the Air Movement and Control Association's (AMCA) specification for static water penetration resistance, achieving a Beginning Point of Water Penetration at a wind velocity of 1250 feet per minute.

In some examples, the louver assembly meets the requirements of the dynamic water test for louver products, demonstrating a water rejection rate exceeding 99% in tests conducted at wind speeds of both 29 miles per hour and 50 miles per hour.

In some examples, the louver assembly adheres to the high-velocity wind-driven rain resistance standard, allowing no more than 1% of the total water volume sprayed during testing to penetrate beyond the louver.

In some examples, the louver assembly meets the criteria for resistance to wind-borne debris at Missile Level E, as defined in the relevant AMCA standard.

In some examples, the exterior sill, the exterior jambs, and the exterior head are formed of an extruded metal are joined to one another at respective corners through at least one of welding, mechanical fasteners, or a combination thereof.

In some examples, the plurality of exterior blades are coupled to the exterior jambs of the exterior frame with mechanical fasteners in a substantially horizontal orientation when the louver assembly is mounted to an exterior building wall.

In some examples, each of the exterior sill, the exterior jambs, the exterior head, and each of the plurality of exterior blades are formed of an extruded 6005-T5 aluminum having a nominal wall thickness ranging approximately from about 3/16 inches to about ¼ inches.

In some examples, the exterior frame further comprises at least one of a flange mounting surface or a cantilever mounting surface extending from the exterior frame to establish either a flush or a cantilevered mounting configuration with an exterior building wall.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows.

FIG. 1 is a front perspective view of a louver assembly, in accordance with an embodiment of the disclosure.

FIG. 2 is a rear perspective view of the louver assembly of FIG. 1.

FIG. 3 is a partially exploded perspective view depicting an exterior frame and an interior frame as separate components of the louver assembly of FIG. 1, in accordance with an embodiment of the disclosure.

FIG. 4 is a partially exploded, perspective view depicting an exterior frame and exterior louver blades, in accordance with an embodiment of the disclosure.

FIG. 5 is a perspective view depicting a connection between an exterior sill and an exterior jamb of an exterior frame, in accordance with an embodiment of the disclosure.

FIG. 6 is a cross-sectional view of an exterior sill, in accordance with an embodiment of the disclosure.

FIG. 6A is a perspective, cross-sectional view of an exterior sill including a flange mounting surface, in accordance with an alternate embodiment of the disclosure.

FIG. 6B is a perspective, cross-sectional view of an exterior sill including a cantilever mounting surface, in accordance with an alternate embodiment of the disclosure.

FIG. 7 is a perspective view depicting a connection between an exterior jamb and an exterior sill of an exterior frame, in accordance with an embodiment of the disclosure.

FIG. 8 is a cross-sectional view of an exterior jamb, in accordance with an embodiment of the disclosure.

FIG. 8A is a perspective, cross-sectional view of an exterior jamb including a flange mounting surface, in accordance with an alternate embodiment of the disclosure.

FIG. 8B is a perspective, cross-sectional view of an exterior jamb including a cantilever mounting surface, in accordance with an alternate embodiment of the disclosure.

FIG. 9 is a perspective view depicting a connection between an exterior head and an exterior jamb of an exterior frame, in accordance with an embodiment of the disclosure.

FIG. 10 is a cross-sectional view of an exterior head, in accordance with an embodiment of the disclosure.

FIG. 10A is a perspective, cross-sectional view of an exterior head including a flange mounting surface, in accordance with an alternate embodiment of the disclosure.

FIG. 10B is a perspective, cross-sectional view of an exterior head including a cantilever mounting surface, in accordance with an alternate embodiment of the disclosure.

FIG. 11 is a partially exploded, perspective view of an exterior louver assembly, in accordance with an embodiment of the disclosure.

FIG. 12 is a cross-sectional view depicting an exterior louver assembly positioned within an exterior frame, in accordance with an embodiment of the disclosure.

FIG. 13 is a cross-sectional view depicting an exterior louver blade, in accordance with an embodiment of the disclosure.

FIG. 14 is a partially exploded, perspective view depicting an interior frame and interior louver blades, in accordance with an embodiment of the disclosure.

FIG. 15 is a close up, partially exploded, perspective of a top portion of an interior frame and interior louver assembly, in accordance with an embodiment of the disclosure.

FIG. 16 is a close up, partially exploded, perspective of a bottom portion of an interior frame and interior louver assembly, in accordance with an embodiment of the disclosure.

FIG. 17 is a close up, partially exploded, perspective view of an interior louver assembly, in accordance with an embodiment of the disclosure.

FIG. 18 is a cross-sectional, perspective view of an interior louver assembly, in accordance with an embodiment of the disclosure.

FIG. 19 is a cross-sectional view of an interior louver blade, in accordance with an embodiment of the disclosure.

FIG. 20 is a louver assembly in a flange mounted configuration, in accordance with an embodiment of the disclosure.

FIG. 21 is a louver assembly in a cantilever mounting configuration, in accordance with an embodiment of the disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

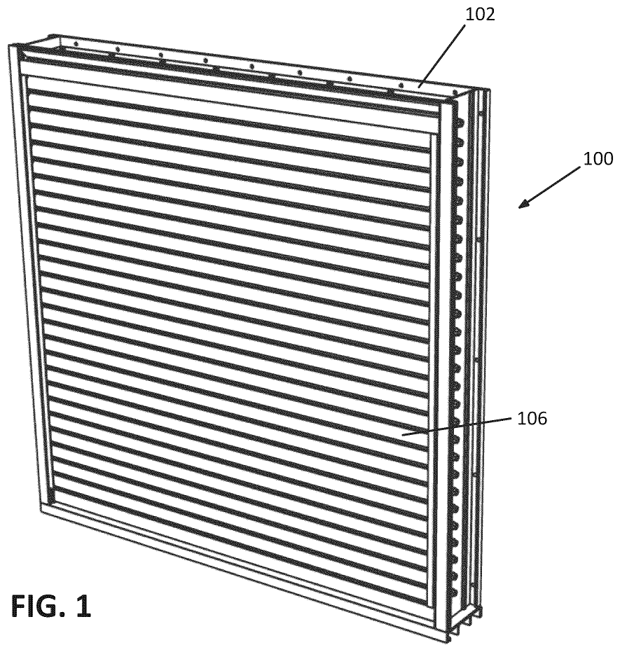

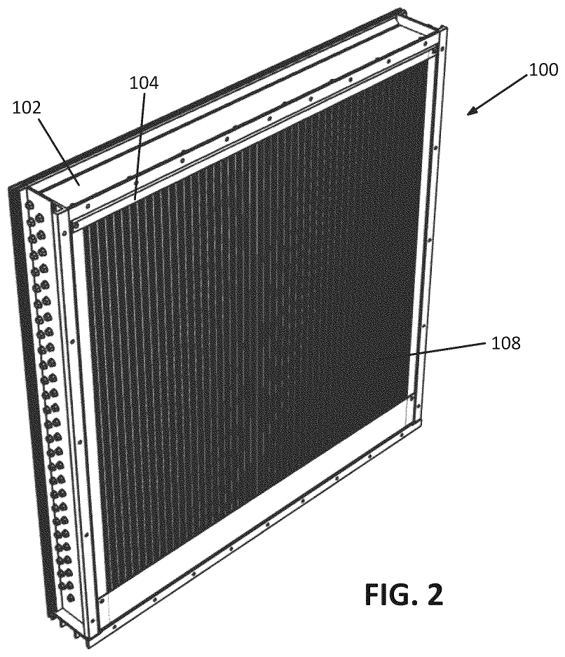

With reference to FIGS. 1-2, a louver 100 configured to deliver performance against wind-driven rain while adhering to impact resistance standards is depicted in accordance with an embodiment of the disclosure. The material composition of louver 100 can include aluminum, steel, other metals, polymers, composite materials, or any suitable alternatives, providing flexibility in design and application.

In compliance with standards prescribed by the Federal Emergency Management Agency (FEMA), the disclosed embodiments fulfill stringent criteria, including impact resistance and the capability to counter wind-driven rain. Certain embodiments exhibit resistance to projectile impacts at velocities ranging between 100 mph and 80 mph on vertical planes, and between 67 mph and 53 mph on horizontal planes. Furthermore, some embodiments demonstrate effective control of water ingress under simulated conditions of 8-inch per hour rainfall at wind speeds reaching 50 mph.

Moreover, specific embodiments are tailored for performance within the parameters set by the ICC 500 (2020 edition) standards, constituted by the International Code Council alongside the National Storm Shelter Association. These standards outline minimal design and construction requirements for storm shelters, emphasizing protection against severe wind-driven rain. According to ICC 500 standards, despite potential penetration and lodging of a missile within a test specimen, it must not perforate a witness paper positioned directly behind, ensuring integrity against high-velocity impacts. Compliance with FEMA P-361 and FEMA P-320 is achieved through debris impact standards involving a 15-pound 2×4 projectile at 100 mph, alongside cycle and static pressure testing as per ASTM E1886 and ASTM E330, respectively. Some disclosed embodiments are able to withstand static pressures up to 350 PSF and impacts from a 15-pound 2×4 at 100 mph.

The AMCA 511-L (2022 edition) standard introduces a static water penetration test for louver products, simulating rain at a vertical descent at 4 inches per hour. This test evaluates the Beginning Point of Water Penetration based on a measurable threshold of 0.01 oz. of water per square foot of free louver area passing through the louver when induced by a fan pulling air and water through the louver from a fully enclosed chamber behind the louver. As disclosed herein, some embodiments are able to withstand wind velocities up to 1250 FPM (maximum testing value).

The dynamic water test standard AMCA 500-L Wind-Driven Rain (2023 edition) pertains to louver products within Hurricane Prone Regions, simulating horizontal rain driven by a wind-generating fan at speeds of either 29 mph or 50 mph. This setup aims to drive rainfall at rates of 3 inches per hour (at 29 mph) or 8 inches per hour (at 50 mph) against the louvers as fan attempts to pull water through the louver from a fully enclosed chamber behind the louver. Louver performance is graded (A to D) based on the percentage of water rejection at increasing inlet velocities (A=99% or greater, B=95%-98.9%, C=80%-94.9%, D=less than 80%). Disclosed embodiments are capable of achieving an “A” grade, indicating 99% or greater water rejection at both tested wind and rainfall intensities and at 5 meters per second core velocity (maximum testing value) at both 29 mph and 3 inches and 50 mph and 8 inches of simulated rainfall per hour.

Embodiments of the present disclosure also conform to AMCA 550 for High Velocity Wind Driven Rain and AMCA 540 for Wind Borne Debris standards, offering protection against extreme weather phenomena. The AMCA standards, specifically AMCA 550 and AMCA 540, benchmark the resistance of louvered devices to wind-driven rain and wind-borne debris, assuring that the products meet elevated performance criteria for safety and endurance.

Under the AMCA 550 High Velocity Wind Driven Rain Standard (2022 Edition), a louver is subjected to external wind speeds of 35, 70, 90, and 110 mph, coupled with horizontal rain at 8.8 inches per hour. Some disclosed embodiments permit no more than 1% of the total sprayed water volume to be collected in the apparatus behind the louver.

The AMCA 540 Wind Borne Debris Standard (2023 edition) tests a louver's resilience against 9-pound 2×4 projectiles at velocities of either 34 mph (Missile Level D) or 55 mph (Missile Level E), with Missile Level D being a prerequisite for commercial constructions and Level E for critical or enhanced facilities. Despite allowable cosmetic destruction, the disclosed embodiments ensure the projectile does not penetrate through the louver, maintaining component connectivity.

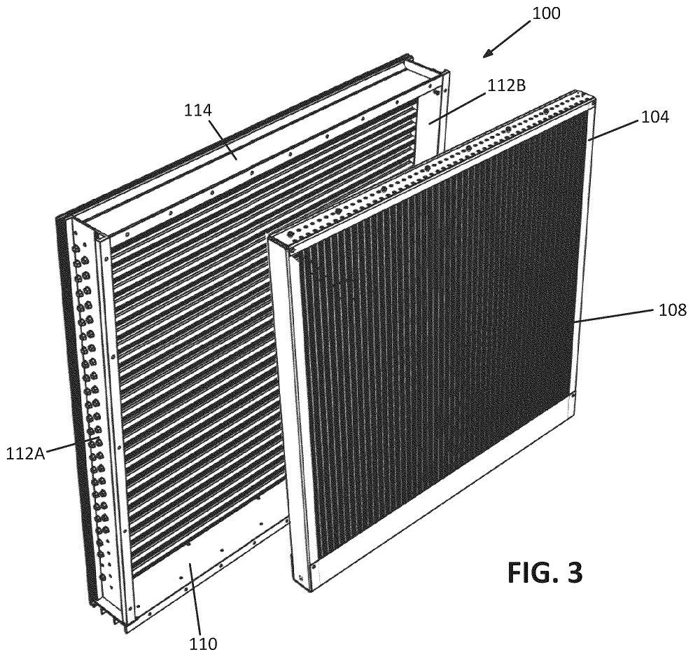

As further depicted in FIG. 3, the louver 100 can generally be comprised of an exterior frame 102 and an interior frame 104 configured to be received within the exterior frame 102. In embodiments, the exterior frame 102 can support an array of exterior louver blades 106, which in some embodiments can be coupled to the exterior frame 102 in a substantially horizontal orientation. The interior frame 104, which can be coupled to the exterior frame 102, can be configured to support an array of interior louver blades 108, which in some embodiments can be coupled to the interior frame 104 in a substantially vertical orientation. Accordingly, in some embodiments, the exterior louver blades 106 can be oriented substantially orthogonal to the interior louver blades 108.

As used herein, positioning and orientational terms such as up, down, upper, lower, above, below, front, back, rear, forward, backward, rearward, horizontal, vertical, and so forth, may be used to refer to relative positioning of components in the louver assembly 100 or portions of a component relative to each other when positioned in an a louver assembly 100. Such terminology is provided as a descriptive aid and does not limit how components or portions of components may be positioned or oriented in practice.

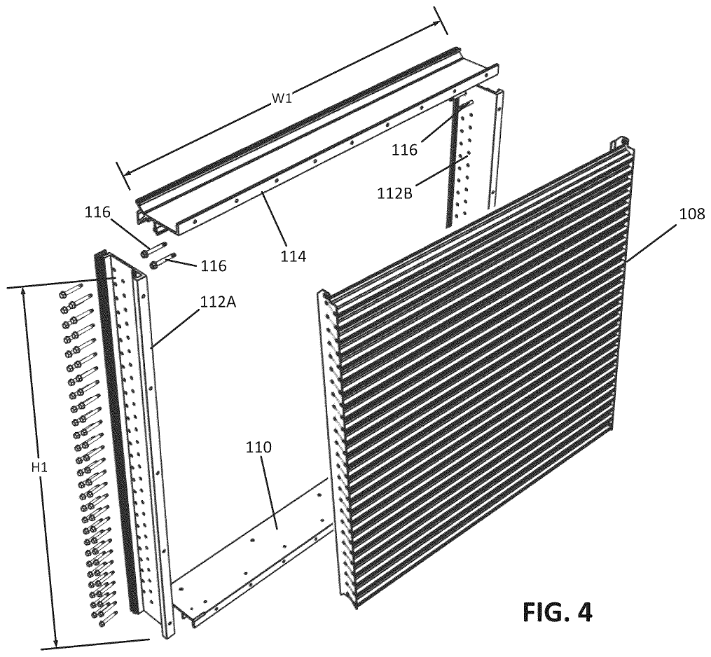

With additional reference to FIG. 4, an exploded view of an exterior frame 102 and an array of exterior louver blades 106 is depicted in accordance with an embodiment of the disclosure. In embodiments, the exterior frame 102 can include an exterior sill 110, opposing (e.g., left and right) exterior jambs 112A, 112B, and an exterior head 114. The exterior frame 102 can have a height H1 (e.g., representing a length of the exterior jambs 112A, 112B) and a width W1 (e.g., representing a length of the exterior sill 110 and exterior head 114).

Assembly techniques for the exterior frame 102 include, but are not limited to, welding and the application of mechanical fasteners. For instance, in some embodiments, the junctures where the exterior sill 110 or the exterior head 114 meet with the exterior jambs 112A, 112B can be secured through welding to enhance structural stability. Alternatively, mechanical fasteners 116 may be utilized to attach the exterior sill 110 or the exterior head 114 to the exterior jambs 112A, 112B, offering flexibility in assembly and repair. Some designs may combine both welding and mechanical fasteners to capitalize on the benefits of each method.

Regarding material specifications, components of the exterior frame 102 can be fabricated from heavy gauge metal to withstand significant environmental stresses. In particular, embodiments of the exterior frame 102 can be constructed from extruded 6005-T5 aluminum, having a nominal wall thickness ranging approximately from 3/16 inches (5 mm) to ¼ inches (6 mm). The inclusion of alternative materials such as steel, other metals, polymers, composite materials, or other suitable substitutes is also within the scope of this invention. These materials can be shaped and assembled using diverse construction techniques to meet the specific requirements of the application, ensuring compliance with relevant standards and regulations.

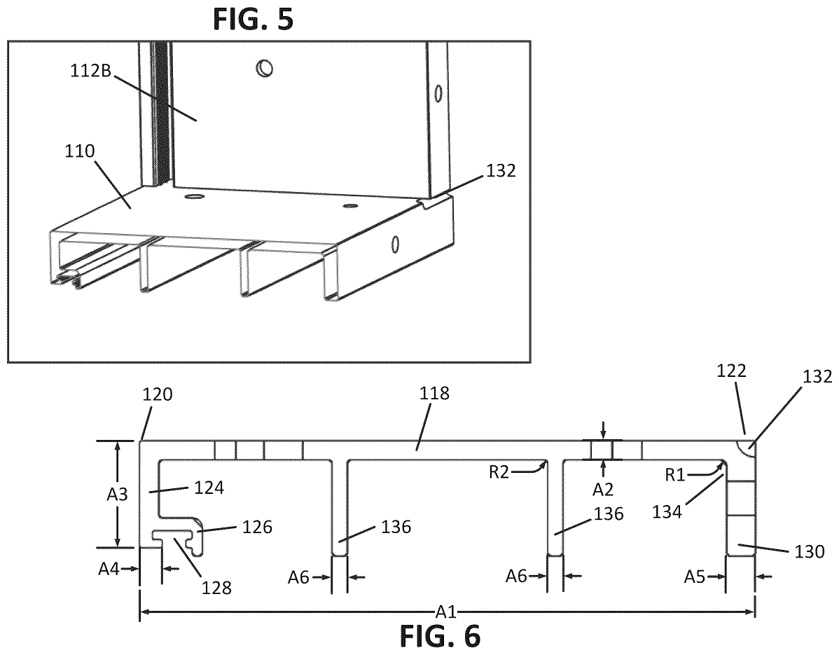

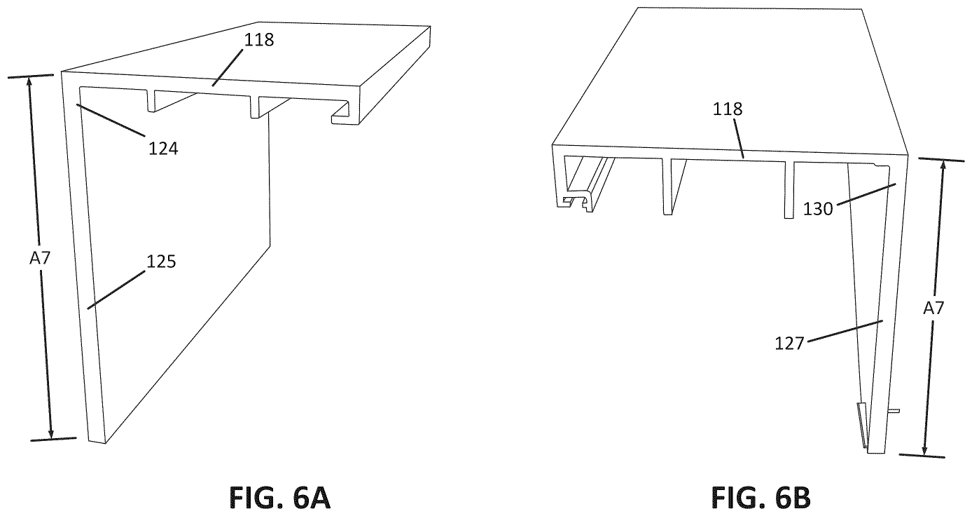

With additional reference to FIGS. 5-6, cross-sectional views of an exterior sill 110 are depicted in accordance with an embodiment of the disclosure. In particular, FIG. 5 depicts an intersection between the exterior sill 110 and an exterior jamb 112B. FIG. 6 is an orthogonal cross-sectional view showing extrusion details and relative dimensions. While FIG. 6 is not limited to any specific scale, the relative dimensions shown depict one exemplary embodiment, and may vary in relative size to emphasize certain features described herein.

The exterior sill 110 includes a sill beam member 118 extending from a front end 120 to a rear end 122 a width A1, and having a thickness A2. A front shield 124 can extend downwardly away from the sill beam member 118 in proximity to the front end 120. For example, in some embodiments, the front shield 124 can extend away from the sill beam member 118 at a substantially orthogonal angle a distance A3. In embodiments, the front shield 124 can have a thickness A4, and can include a channel supporting portion 126, defining a channel 128 (e.g., T-shaped channel, etc.).

A rear shield 130 can extend downwardly from the sill beam number 118 in proximity to the rear end 122. For example, in some embodiments, the rear shield 130, which can have a thickness A5, can extend away from the sill beam member 118 at a substantially orthogonal angle the distance A3. In some embodiments, a filleted corner 134 having a radius R1 can be defined on the inner orthogonal angle defined between the rear shield 130 and the sill beam member 118. In some embodiments, the radius R1 of the filleted corner 134 can be larger than the radii R2 of other filleted corners defined by the exterior sill 110. A weld channel 132 can be defined at an intersection between the exterior sill 110 and the exterior jambs 112A, 112B for the receipt of weld material.

In some embodiments, one or more support members 136 can extend from the sill beam member 118 to add rigidity or support to the exterior sill 110. In one embodiment, the exterior sill 110 includes two support members 136, each having a thickness A6, extending at a substantially orthogonal angle to the sill beam member 118.

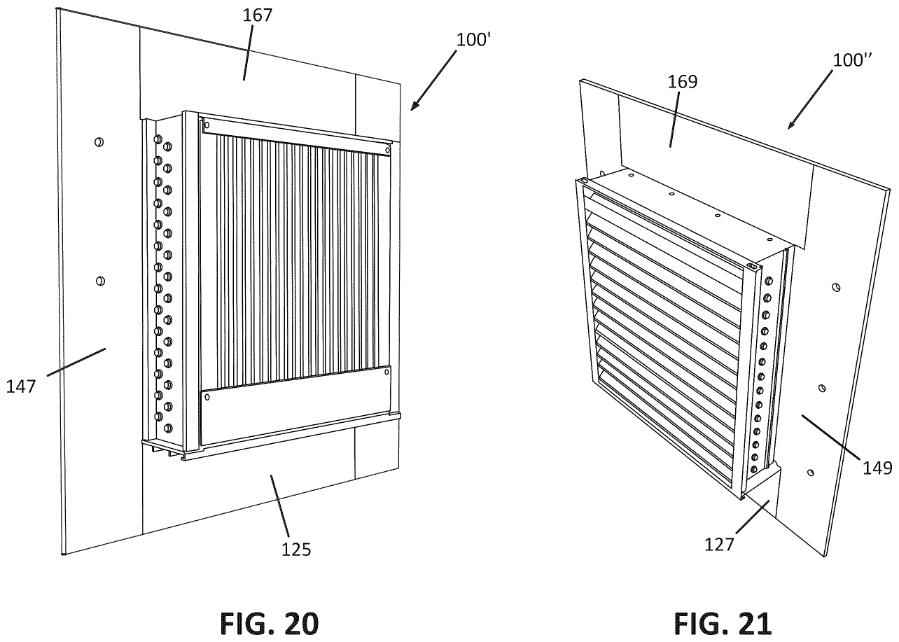

Additionally, as depicted in FIGS. 6A and 6B, in some embodiments, either a flange mounting surface 125 or a cantilever mounting surface 127 can be extended from the front shield 124 or the rear shield 130 a distance A7 to establish a flush mounting surface with an exterior building wall in either of a flanged mounting configuration (as depicted in FIG. 20) or cantilevered mounting configuration (as depicted in FIG. 21).

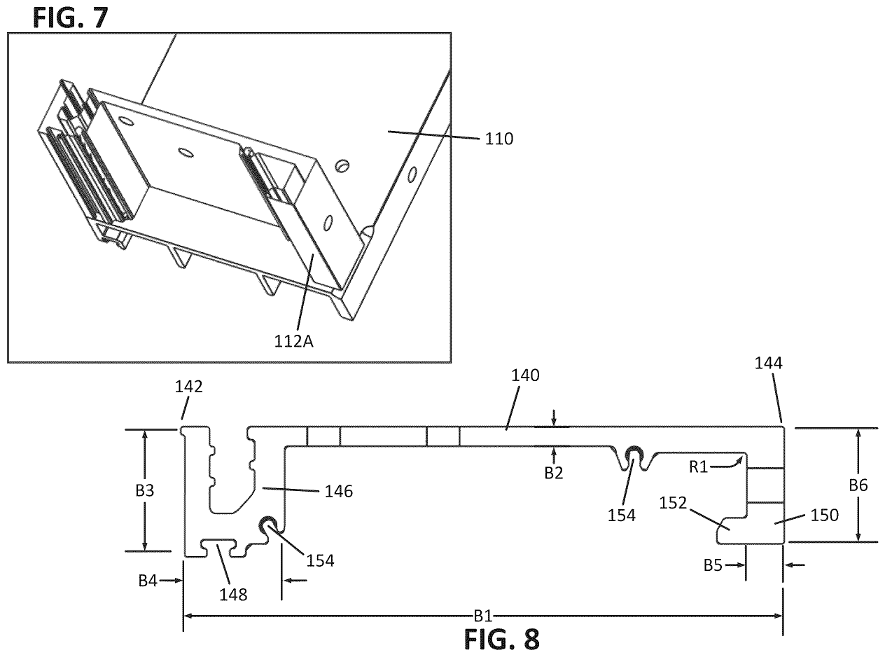

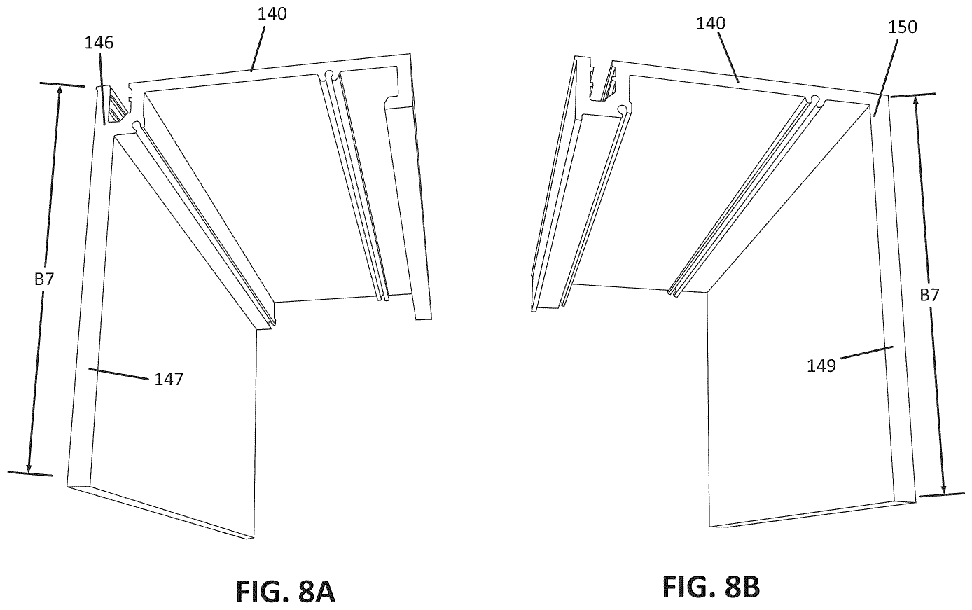

With additional reference to FIGS. 7-8, cross-sectional views of an exterior jamb 112 are depicted in accordance with an embodiment of the disclosure. In particular, FIG. 7 depicts an intersection between the exterior sill 110 and an exterior jamb 112A. FIG. 8 is an orthogonal cross-sectional view showing extrusion details and relative dimensions. While FIG. 8 is not limited to any specific scale, the relative dimensions shown depict one exemplary embodiment, and may vary in relative size to emphasize certain features described herein.

The exterior jamb 112 includes a jamb beam member 140 extending from a front end 142 to a rear end 144 having a width B1 (e.g., which can be substantially equal to width A1), and having a thickness B2. A front shield 146 can extend outwardly away from the jamb beam member 140 in proximity to the front end 142. For example, in some embodiments, the front shield 146 can extend away from the jamb beam member 140 at a substantially orthogonal angle a distance B3. In embodiments, the front shield 146 can have a thickness B4, and can define a channel 148 (e.g., a T-shaped channel configured to enable continuation of the seal positioned in channel 128).

A rear shield 150 can extend downwardly from the jamb beam member 140 in proximity to the rear end 144. For example, in some embodiments, the rear shield 150, which can have a thickness B5, and can extend away from the jamb beam member 140 at a substantially orthogonal angle a distance B6. In some embodiments, a fillet corner having a radius R1 can be defined on the inner orthogonal angle defined between the rear shield 150 and the jamb beam member 140. In some embodiments, a protrusion 152 can extend from the rear shield 150 at a substantially orthogonal angle, for example to improve structural rigidity of the exterior jamb 112.

Additionally, in some embodiments, the exterior jamb 112 can define one or more fastener receptacles 154 configured to secure the exterior louver blades 106 to the exterior frame 102. In some embodiments, the one or more fastening receptacles can be defined as open grooves, enabling moisture to drain therefrom.

Additionally as depicted in FIGS. 8A and 8B, in some embodiments, either of a flange mounting surface 147 or a cantilever mounting surface 149 can be extended from the front shield 146 or the rear shield 150 a distance B7 to establish a flush mounting surface with an exterior building wall in either of a flanged mounting configuration (as depicted in FIG. 20) or cantilevered mounting configuration (as depicted in FIG. 21).

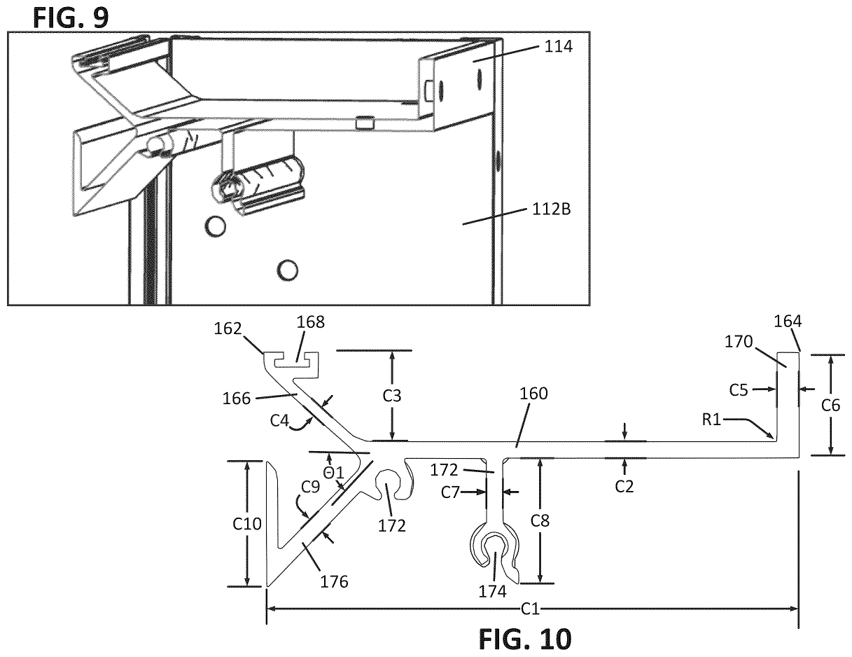

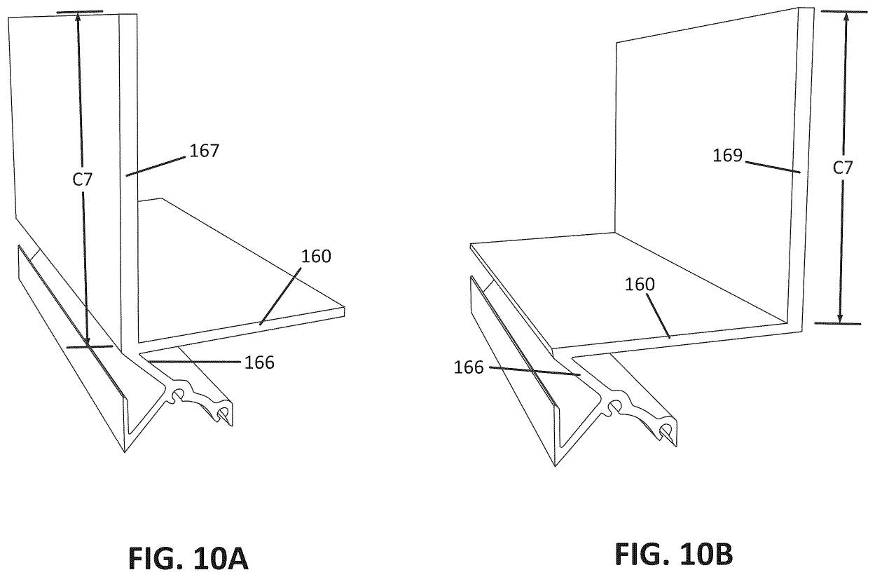

With additional reference to FIGS. 9-10, cross-sectional views of an exterior head 114 are depicted in accordance with an embodiment of the disclosure. In particular, FIG. 9 depicts an intersection between the exterior head 114 and an exterior jamb 112B. FIG. 10 is an orthogonal cross-sectional view showing extrusion details and relative dimensions. While FIG. 10 is not limited to any specific scale, the relative dimensions shown depict one exemplary embodiment, and may vary in relative size to emphasize certain features described herein.

The exterior head 114 includes a head beam member 160 extending from a front end 162 to a rear end 164 a width C1 (e.g., which can be substantially equal to widths A1, B1), having a thickness C2. A front shield 166 can extend outwardly away from the head beam member 160 in proximity to the front end 162. For example, in some embodiments, the front shield 166 can extend away from the head beam member 160 at a substantially orthogonal angle a distance C3. In embodiments, the front shield 166 can have a thickness C4, and can define a channel 168 (e.g., a T-shaped channel configured to enable continuation of the seal positioned in channels 128, 148).

A rear shield 170 can extend downwardly from the head beam member 160 in proximity to the rear end 164. For example, in some embodiments, the rear shield 170, which can have a thickness C5, and can extend away from the jamb beam member 140 at a substantially orthogonal angle a distance C6. In some embodiments, a filleted corner having a radius R1 can be defined on the inner orthogonal angle defined between the rear shield 170 and the head beam member 160.

In some embodiments, one or more support members 172 can extend from the head beam member 160 to add rigidity or support to the exterior head 114. For example, the support members 172 can have a thickness C7, extending at a substantially orthogonal angle to the head beam member 160 a distance C8. Additionally, in some embodiments, the head beam member 160 can define one or more fastener receptacles 174 configured to secure the head beam member 160 to the exterior jambs 112. In some embodiments, the one or more fastener receptacles 174 can be defined in open grooves, enabling moisture to drain therefrom.

Additionally, in some embodiments, the head beam member 160 can define an exterior louver blade portion 176, which can be configured to angle away from the head beam member 160 at angle Θ1 (e.g., about 45°, etc.), to form a substantially orthogonal angle with the front shield 166 extension). In some embodiments, the exterior louver blade portion 176 can include two legs to form two sides of a partial isosceles triangle, with the front shield 166 forming the third side of the triangle, and with a partial hypotenuse of the triangle formed by the second leg of the exterior louver blade portion 176 positioned in a substantially vertical orientation in proximity to a front end 162 of the exterior head 114.

Additionally as depicted in FIGS. 10A and 10B, in some embodiments, either a flange mounting surface 167 or a cantilever mounting surface 169 can be extended from the front shield 166 a distance C9 to establish a flush mounting surface with an exterior building wall in either of a flanged mounting configuration (as depicted in FIG. 20) or cantilevered mounting configuration (as depicted in FIG. 21).

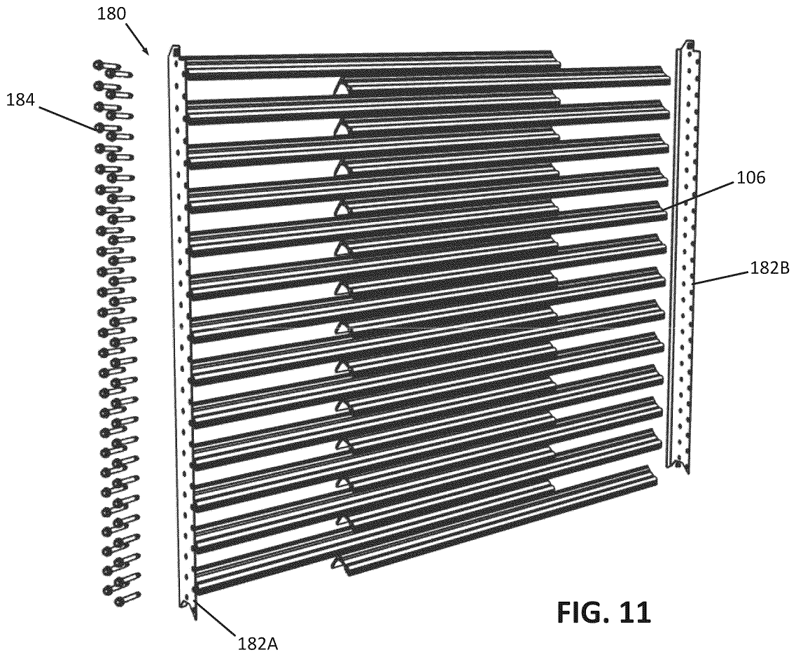

FIG. 11 depicts an exterior louver assembly 180 of exterior louver blades 106. In some embodiments, the exterior louver assembly 180 can include a total of twenty-six exterior louver blades 106; although the inclusion of a greater or fewer number of exterior louver blades 106 is also contemplated. To facilitate ease in operably coupling the exterior louver blades 106 to the exterior frame 102, in some embodiments, a pair of end plates 182A, 182B can be positioned on opposing sides of the exterior louver blades 106. A plurality of fasteners 184 can be used to couple the exterior louver assembly 180 to the exterior frame 102.

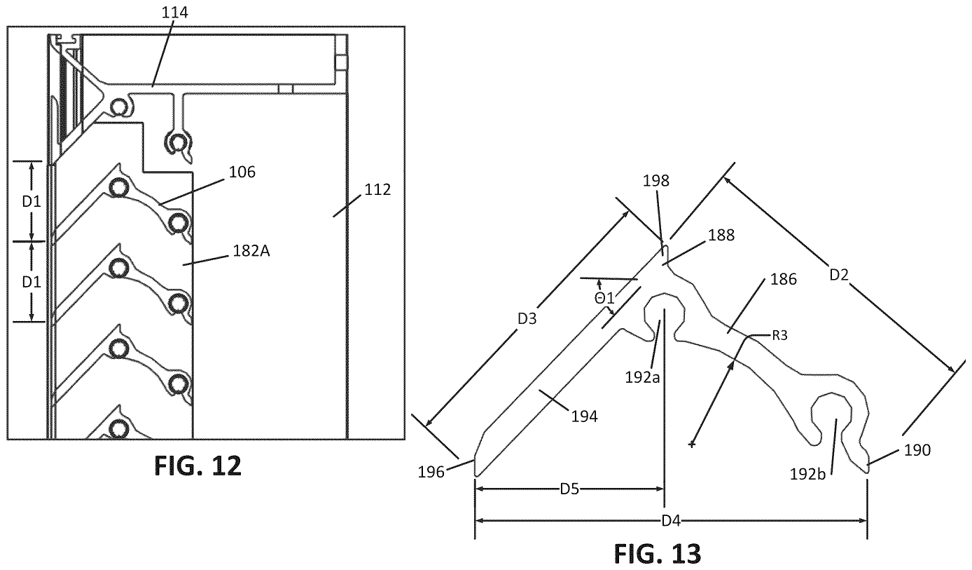

FIG. 12 depicts a cross-sectional view of the exterior louver assembly 180 positioned within the exterior frame 102, such that each of the exterior louver blades 106 of the exterior louver assembly 180 are spaced apart distance D1, which can be the same spacing between the top exterior louver blade 106A and the exterior louver blade portion 176 of the head beam member 160.

FIG. 13 is an orthogonal cross-sectional view of an exterior louver blade 106 showing extrusion details and relative dimensions. While FIG. 13 is not limited to any specific scale, the relative dimensions shown depict one exemplary embodiment, and may vary in relative size to emphasize certain features described herein. In embodiments, the exterior louver blade 106 can generally have a V-shaped form, including a front portion 194 and a rear portion 186 joined at an angle to form a peak 198 at a general midpoint of the blade 106. In one characterization, the rear portion 186 is a curved portion and the front portion 194 is an exterior-facing louver blade portion. The rear portion 186 can extend along a curve or radius R3 between an apex 188 and a second end 190 a distance D2. In some embodiments, the rear portion 186 can define one or more fastener receptacles or bosses 192 (shown as 192a, 192b in FIG. 13) configured to receive fasteners 189 to secure the exterior louver blades 106 to the exterior frame 102. As shown, boss 192a is shown as being located proximate the peak of the blade 188 while boss 192b is shown as being located proximate the end 190. Notably, the blade 106 is configured such that no boss is located proximate the front end 196. Stated another way, no boss is provided on the blade 106 that is mor proximate the front end 196 than to the midpoint or apex of the blade. In some embodiments, the one or more fastener receptacles or bosses 192 can be defined in open grooves, enabling moisture to drain therefrom. With continued reference to FIG. 13, it can be seen that the blade extends a distance D4 between the blade ends 196, 190 with the boss 192a being located at a distance D5 from the blade end 196. In some examples, distance D5 is about half of distance D4. In some examples, distance D5 is within 10% of half the distance D4. In some examples, the boss 192a can be characterized as being located remote from the front blade end and/or located within the middle third of the blade width. In some characterizations, the blade 106 can be said to be free of bosses within the front quarter and/or front third of the blade width. In some examples, the boss 192a is located such that it is more proximate the end 190 than to the end 196.

Additionally, the front portion 194 can extend at angle Θ1 from the apex 188 to a first end 196 over a distance D3, such that a plane formed by front portion 194 is in parallel alignment with a plane formed by the exterior louver blade portion 176 of the head beam member 160. In some embodiments, the apex 188 can be defined by a peak 198 or spire, having one surface coplanar with a major surface defined by the front portion 194 and an adjacent rear-facing vertical surface. In some examples, the angle Θ1 is between about 30 and 60 degrees, between about 40 and 50 degrees, and about 45 degrees. In some examples, D2 and D3 are about the same distance. In some examples, the blade portions and are oriented at an obtuse angle to each other, when using a line or plane passing through the centerlines of bosses 192 as a reference point for blade portion and a line or plane colinear/coplanar with the front face of the front portion 194. In one example, the angle between front portion 194 and the front portion 186 is between about 90 and 110 degrees, and about 100 degrees.

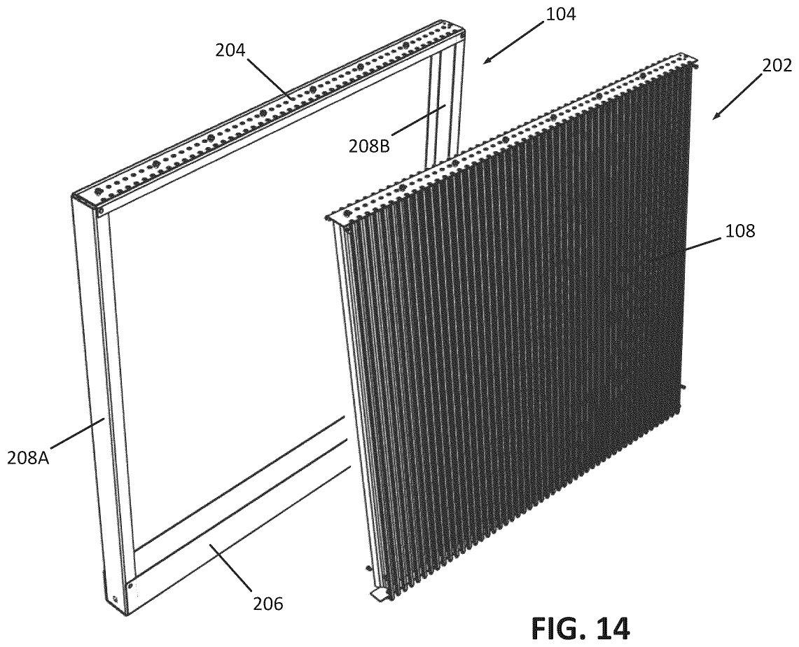

Referring to FIG. 14, an interior frame 104 and an interior louver assembly 202 of interior louver blades 108 is depicted in accordance with an embodiment of the disclosure. In embodiments, the interior louver assembly 202 can be received within and coupled to the interior frame 104.

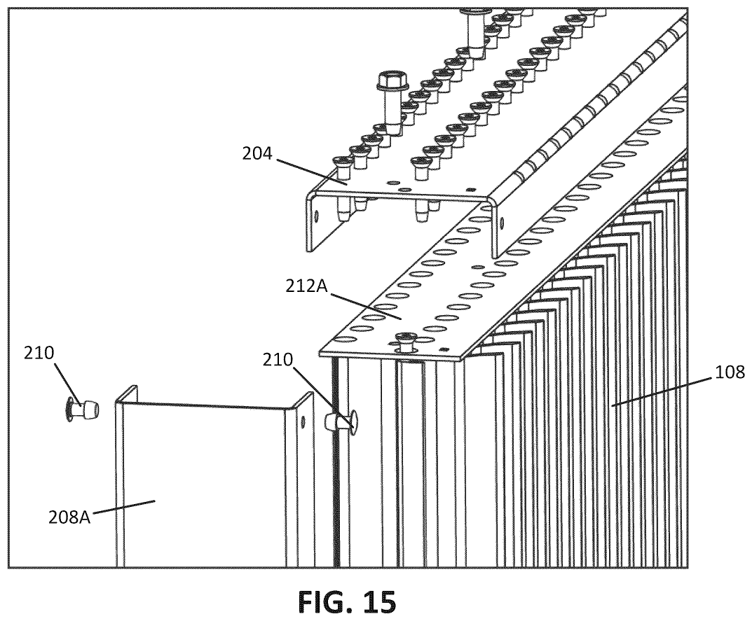

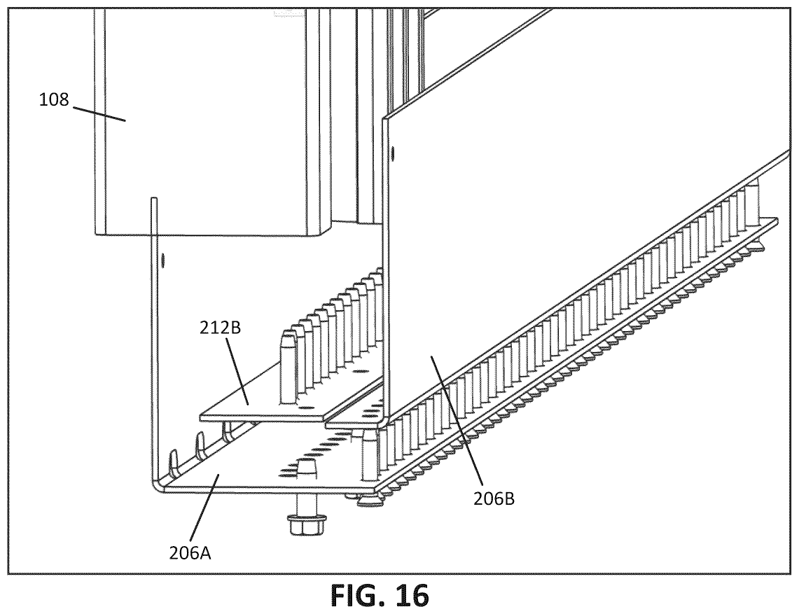

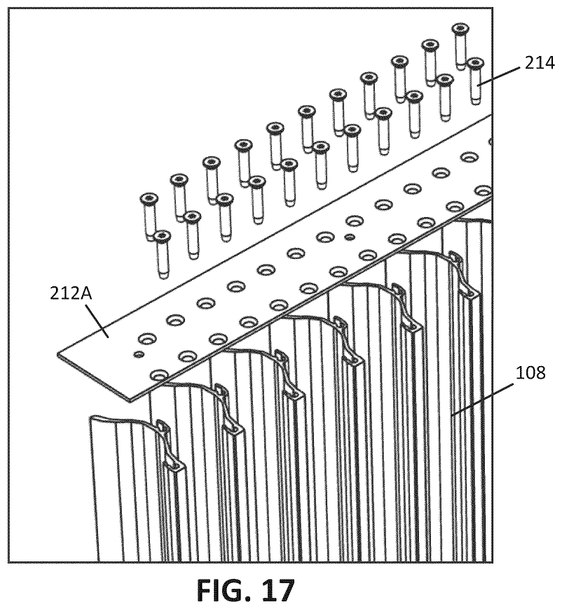

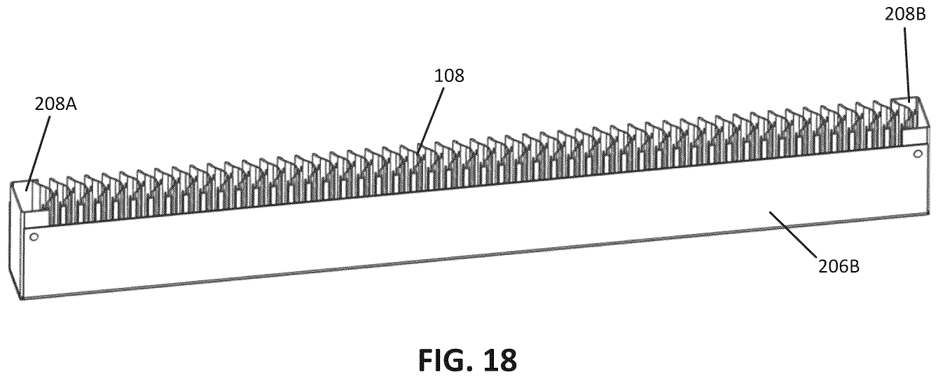

As further depicted in FIGS. 15-18, the interior frame 104 can be comprised of a top portion 204, a bottom portion 206, and a pair of side portions 208A, 208B. In embodiments, the various portions of the interior frame 104 can be constructed of a rigid material (e.g., sheet metal, etc.) having a cross-section (e.g., a C-shaped cross-section, etc.) configured to receive a portion of the interior louver assembly 202. In embodiments, each of the top portion 204 and pair of side portions 208A, 208B can be formed as single components, and can be coupled to one another through a variety of techniques, including the use of welding, adhesives, and mechanical fasteners. As depicted, in one embodiment, the top portion 204 can be coupled to the side portions 208A, 208B via rivets 210.

Operable coupling of the bottom portion 206 to the side portions 208A, 208B can be completed in a similar manner, with the exception that in some embodiments, the bottom portion 206 can comprise a first bottom portion 206A and a second bottom portion 206B, which together form the bottom portion 206, thereby enabling a portion of the interior louver assembly 202 to be positioned within the cross-section of the top portion 204, bottom portion 206, and pair of side portions 208A, 208B.

In some embodiments, the interior louver assembly 202 can include a total of fifty interior louver blades 108, although the inclusion of a greater or fewer number of interior louver blades 108 is also contemplated. To facilitate use in operably coupling the interior louver blades 108 to the interior frame 104, in some embodiments, a pair of end plates 212A, 212B can be positioned on opposing sides of the interior louver blades 108. A plurality of fasteners 214 can be used to couple the interior louver assembly 202 to the interior frame 104. As depicted, in some embodiments, the interior louver blades 108 can be oriented in a substantially vertical orientation, while the exterior louver blades 106 are oriented in a substantially horizontal orientation, such that the interior louver blades 108 are substantially orthogonal to the exterior louver blades 106.

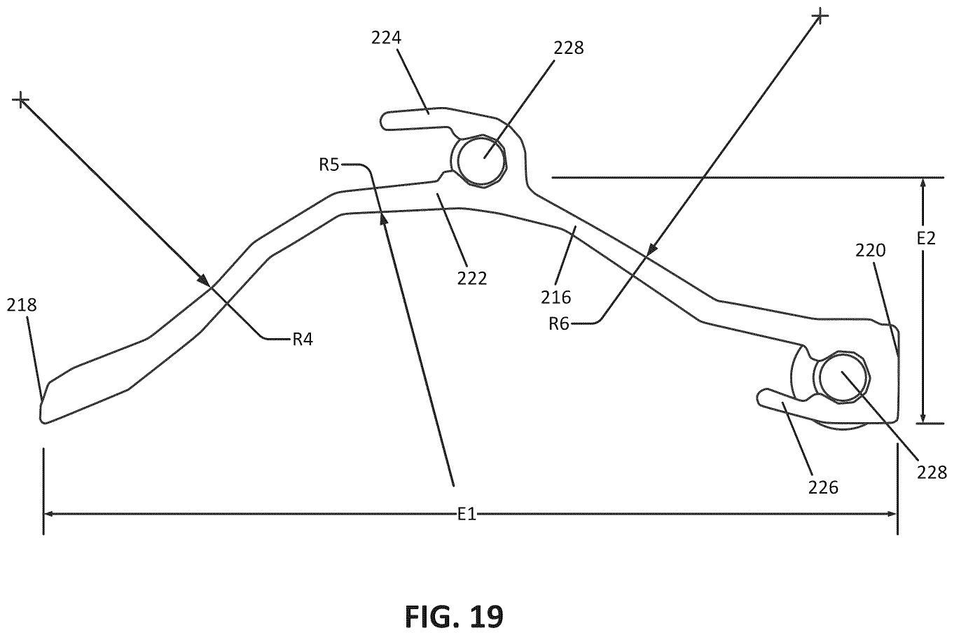

FIG. 19 is an orthogonal cross-sectional view of an interior louver blade 108 showing extrusion details and relative dimensions. While FIG. 19 is not limited to any specific scale, the relative dimensions shown depict one exemplary embodiment, and may vary in relative size to emphasize certain features described herein.

As depicted, in one embodiment, the interior louver blade 108 can include a curved member 216 extending from a first end 218 to a second end 220 over a distance E1. In some embodiments, the curved member 216 follows a tangent line between a series of radii (e.g., R4, R5, and R6, etc.) to define an arcuate curve having a rise and fall over a distance E2, between the respective first end 218 and the second end 220 with an apex 222 of the arcuate curve positioned between the first end 218 and the second end 220.

In some embodiments, the interior louver blade 108 can define one or more hooks 224, 226. For example, a first hook 224 can be defined in proximity to the apex 222, and a second hook 226 can be defined in proximity to the second end 220. In embodiments, both the first hook 224 and the second hook 226 can define a fastener receptacle 228 configured to receive fasteners 214 to secure the interior louver blades 108 to the interior frame 104. In some embodiments, the one or more fastener receptacles 228 can be defined in open grooves, enabling moisture to drain therefrom. In the example shown, the hooks 224, 226 extend in a forward direction and can aid in reducing moisture penetration of the louver.

FIG. 20 depicts a louver assembly 100 in a flange mounting configuration, in which the exterior frame 102 includes a flange mounting surface 125, 147, 167 positioned on an exterior, outwardly facing side of the louver assembly 100, such that a front end of the exterior frame 102 is substantially flush with an exterior building wall. FIG. 21 depicts a louver assembly 100 in a cantilevered mounting configuration, in which the exterior frame 102 includes cantilever mounting surfaces 127, 149, 169 positioned on an interior, inwardly facing side of the louver assembly 100, such that a front end of the exterior frame 102 is cantilevered outwardly away from an exterior building wall.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A louver assembly comprising:
a) a frame;
b) a first plurality of blades secured to the frame, the first plurality of blades being spaced apart and extending parallel to each other in a first direction, the first plurality of blades having a chevron-shape;
c) a second plurality of blades secured to the frame, the second plurality of blades being spaced apart and extending parallel to each other in a second direction orthogonal to the first direction, the second plurality of blades having an arc-shape;
d) wherein the louver assembly meets a minimum impact resistance test threshold and a minimum moisture penetration test threshold:
i) the minimum impact resistance test threshold being defined as a louver assembly that prevents a projectile, weighing at least 9 pounds and having a 2×4-inch cross-section, travelling at least at 34 miles per hour, from penetrating through the louver assembly; and
ii) the minimum moisture penetration test threshold being defined as a louver assembly that prevents no more than 1% of a horizontally sprayed water stream, flowing at a rate of at least 3 inches per hour, from penetrating through the louver assembly.

2. The louver assembly of claim 1, wherein the louver assembly is capable of withstanding a structural loading of greater than 300 pounds per square foot.

3. The louver assembly of claim 1, wherein the minimum impact resistance threshold is defined by ICC-500-2023.

4. The louver assembly of claim 1, wherein the louver assembly has a beginning point of water penetration of at least 1000 feet per minute, as defined within Air Movement and Control Association (AMCA) 511-2022.

5. The louver assembly of claim 1, wherein the minimum moisture penetration test threshold is defined by AMCA 500-L-2023, and wherein the louver assembly has a rejection rate of water greater than 99%, for both a 29 mile-per-hour test and a 50 mile-per-hour test, as defined within AMCA 500-L-2023.

6. The louver assembly of claim 1, wherein the minimum moisture penetration test threshold is defined by AMCA 550-2022, with less than 1% of a total sprayed water volume penetrated behind the louver assembly, as defined within AMCA 550-2022.

7. A louver assembly comprising:
an exterior frame; and
a plurality of chevron-shaped exterior louver blades, wherein each exterior louver blade extends from a first end to a second end, with an apex located therebetween, wherein each exterior louver blade defines one or more fastener receptacles located between the apex and the second end, facilitating attachment of each exterior louver blade to the exterior frame, wherein each of the exterior louver blades is free from a fastener receptacle proximate a front end of each blade.

8. The louver assembly of claim 7, wherein the louver assembly is capable of withstanding a structural loading of at least 350 pounds per square foot.

9. The louver assembly of claim 8, wherein the louver assembly complies with standards equivalent to those specified for storm shelter design and construction, as verified through third-party testing and certification by recognized services, enabling its application in structures designed for severe weather protection.

10. The louver assembly of claim 8, wherein the louver assembly conforms to the Air Movement and Control Association's (AMCA) specification for static water penetration resistance, achieving a Beginning Point of Water Penetration at a wind velocity of 1250 feet per minute.

11. The louver assembly of claim 8, wherein the louver assembly meets the requirements of the dynamic water test for louver products, demonstrating a water rejection rate exceeding 99% in tests conducted at wind speeds of both 29 miles per hour and 50 miles per hour.

12. The louver assembly of claim 8, wherein the louver assembly adheres to the high-velocity wind-driven rain resistance standard, allowing no more than 1% of the total water volume sprayed during testing to penetrate beyond the louver.

13. The louver assembly of claim 8, wherein the louver assembly meets the criteria for resistance to wind-borne debris at Missile Level E, as defined in the relevant AMCA standard.

14. A louver assembly, comprising:
an exterior frame including an exterior sill, exterior jambs, and an exterior head;
a plurality of exterior louver blades arranged in parallel and mechanically coupled to the exterior frame in a first orientation; and
a plurality of interior louver blades arranged in parallel and mechanically coupled to the exterior frame in a second orientation, wherein the second orientation is substantially orthogonal to the first orientation.

15. The louver assembly of claim 14, wherein the louver assembly is capable of withstanding a structural loading of at least 350 pounds per square foot.

16. The louver assembly of claim 14, wherein the louver assembly complies with standards equivalent to those specified for storm shelter design and construction, as verified through third-party testing and certification by recognized services, enabling its application in structures designed for severe weather protection.

17. The louver assembly of claim 14, wherein the louver assembly conforms to the Air Movement and Control Association's (AMCA) specification for static water penetration resistance, achieving a Beginning Point of Water Penetration at a wind velocity of 1250 feet per minute.

18. The louver assembly of claim 14, wherein the louver assembly meets the requirements of the dynamic water test for louver products, demonstrating a water rejection rate exceeding 99% in tests conducted at wind speeds of both 29 miles per hour and 50 miles per hour.

19. The louver assembly of claim 14, wherein the louver assembly adheres to the high-velocity wind-driven rain resistance standard, allowing no more than 1% of the total water volume sprayed during testing to penetrate beyond the louver.

20. The louver assembly of claim 14, wherein the louver assembly meets the criteria for resistance to wind-borne debris at Missile Level E, as defined in the relevant AMCA standard.
